(19) United States
(12) Patent Application Publication
(10) Pub. No.: US 2025/0225415 A1
(43) Pub. Date: Jul. 10, 2025

(54) SYSTEM AND METHOD FOR REAL-TIME BIODATA ANALYSIS AND PERSONALIZED RESPONSE ADAPTATION

(71) Applicant: Rana June Sobhany, Lakewood Ranch, FL (US)

(72) Inventor: Rana June Sobhany, Lakewood Ranch, FL (US)

(21) Appl. No.: 19/065,430

(22) Filed: Feb. 27, 2025

Related U.S. Application Data
(60) Provisional application No. 63/619,701, filed on Jan. 10, 2024.

(51) Int. Cl. G06N 5/04

(52) U.S. Cl. CPC G06N 5/04

(57) ABSTRACT

An emotionally intelligent system includes one or more sensors configured to collect biodata associated with a user and a processor in communication with the one or more sensors. The processor is configured to receive the biodata associated with the user and determine, using one or more artificial intelligence models and based at least in part on the biodata, an emotional state of the user. The processor or another device is configured to modify or adjust an output provided to the user based at least in part on the emotional state of the user.

### CROSS-REFERENCE TO RELATED APPLICATIONS

This application is related to and claims priority from U.S. Provisional Patent Application No. 63/619,701, titled “A method for generating personalized insight through biofeedback interpolation using emotionally intelligent AI,” the contents of which are incorporated herein in their entirety.

### TECHNICAL FIELD

This disclosure relates to systems and methods for personalized insight generation. More specifically, certain embodiments are directed to systems and methods for real-time biodata analysis and personalized response adaptation.

### BACKGROUND

AI models have been used for simulating and understanding human knowledge. However, despite strides in achieving explicitly stated data interpretation, current AI methods are incapable of attaining genuine human-like attributes beyond mimicry and are limited by the fundamental static nature of linguistic data. A need exists for a new generation of AI that is capable of proficiently analyzing, interpreting, and conveying the full spectrum of human emotion and experience.

### SUMMARY

The systems and methods of this disclosure provide an improved approach to AI decision-making and are designed to integrate real-time physiological data, adaptive reasoning, and predictive emotional engagement into a self-modulating AI system. Unlike previous AI systems that rely solely on pre-trained datasets, probabilistic outputs, or static rules, the systems and methods of this disclosure allow AI to develop situational awareness, real-time intuition, and context-driven self-regulation. These capabilities allow more human-like interactions between humans and machines, such as chatbots, humanoid robots, AI companions, and other AI systems. For example, intelligence in humanoid robotics and AI companionship requires an advanced cognition model that allows for real-time self-modulation. Current AI systems rely on either pre-programmed behavior, probabilistic response generation, multimodal or single-variable reactive inputs. These approaches result in AI that lacks full contextual flexibility, adaptive reasoning, and the ability to anticipate shifts in human interaction.

An aspect of the present disclosure is directed to a system comprising: one or more sensors configured to collect biodata associated with a user and a processor in communication with the one or more sensors. The processor is configured to: receive the biodata associated with the user; process the biodata using one or more artificial intelligence models to determine an emotional state of the user, wherein the emotional state is a prediction inferred by the processor based on psychophysiological signals derived from the biodata; and generate an output, modification, or intervention based at least in part on the inferred emotional state of the user. A device is configured to: provide an output for the user; receive or obtain the inferred emotional state of the user; and modify or adjust the output provided to the user based at least in part on the inferred emotional state of the user.

In some embodiments, the processor is further configured to determine a user credibility weighting based at least in part on the received biodata. In some embodiments, the processor is further configured to: determine a cognitive load of the user based on the biodata; and adapt complexity of information provided to the user as part of the modified output based on the cognitive load.

In some embodiments, the device is further configured to: provide an audible artificial voice interaction with the user; and adjust properties of the artificial voice interaction based on the inferred emotional state of the user. In some embodiments, the device is further configured to: generate, using a reasoning algorithm, a linguistic cue to the user; receive a response to the linguistic cue from the user; adjust the reasoning algorithm based on the biodata; and generate, using the adjusted reasoning model, a modified linguistic cue taking into account the inferred emotional state of the user.

In some embodiments, the processor is further configured to preprocess the biodata by performing one or more of data normalization, data filtering, data transformation, and feature extraction and selection on the biodata. In some embodiments, the processor is further configured to: determine a longitudinal trend in the received biodata over a period of time; detect a deviation in the inferred emotional state of the user; and provide a proactive intervention for addressing the deviation in the inferred emotional state of the user.

In some embodiments, the device comprises an electronic display, speaker, a haptic device, lighting, an augmented reality display, or a virtual reality display. In some embodiments, the device is a component of a vehicle, a smart home, a workspace, a lighting system, a sound system, a gaming system, or a virtual reality/augmented reality system.

In some embodiments, the biodata comprises multimodal data corresponding to a plurality of biometric signals of the user, and the processor is further configured to: preprocess the multimodal data to generate preprocessed multimodal data; synchronize the preprocessed multimodal data to generate fused data; and perform data interpolation and predictive modeling on the fused data to generate the prediction of the inferred emotional state of the user using the fused data as an input to the one or more artificial intelligence models.

In some embodiments, the processor is further configured to generate or update a profile of the user comprising at least one of psychographic, physiological, and cognitive characteristics of the user. In some embodiments, the processor is further configured to iteratively update the prediction of the inferred emotional state of the user using a multi-stage feedback mechanism. In some embodiments, the processor is further configured to predict a long-term emotional state of the user, using the predictions of the inferred emotional state that are iteratively updated over time. In some embodiments, the device is further configured to: present a user interface to the user; and adjust properties of the user interface based on the inferred emotional state of the user.

In some embodiments, the device is further configured to: provide one or both of lighting and sound to a space; and adjust properties of one or both of the lighting and sound based on the inferred emotional state of the user. In some embodiments, the device is a component of a vehicle and is further configured to modify at least one of seat ergonomics, ambient lighting, sound ambiance, air temperature, and haptic feedback based on the inferred emotional state of the user.

In some embodiments, the biodata comprises at least one of heart rate of the user, heart rate variability of the user, skin galvanic response of the user, facial micro-expression of the user, a respiration rate of the user, a vocal tone of the user, and a neural oscillation pattern of the user.

In some embodiments, the processor is further configured to: detect any of a cognitive strain, neurocognitive strain, or fatigue using the biodata; and the device is further configured to receive an indication of the detected cognitive load, neurocognitive strain, and/or fatigue and provide a corresponding intervention. In some embodiments, the device is a humanoid robot. In some embodiments, the processor is further configured to make the emotional state of the user available to an application programming interface, the application programming interface configured to communicate with an application executed on the device.

In some embodiments, the one or more sensors are configured to collect group biodata associated with a group of users; the processor is configured to: receive the group biodata; process the group biodata using the one or more artificial intelligence models to determine a member emotional state of each individual in the group, wherein the member emotional state is a prediction inferred by the processor based on psychophysiological signals for each individual in the group derived from the group biodata; and generate a group output, group modification, or group intervention based at least in part on the inferred emotional state of each individual in the group; and the device is configured to: provide group output, group modification, or group intervention to at least one individual in the group.

Another aspect of the present disclosure is directed to a method, comprising, by one or more processors: receiving biodata associated with a user from one or more sensors; preprocessing the biodata using data normalization, feature extraction and/or signal filtering techniques; determining, using one or more artificial intelligence models and at least a portion of the biodata, an emotional state of the user, wherein the emotional state is a prediction inferred by the one or more processors based on psychophysiological signals derived from the biodata; modifying or adjusting an output, interaction, or intervention provided to the user based at least in part on the inferred emotional state; and iteratively updating the inferred emotional state using a feedback loop based on newly received biodata.

Another aspect of the present disclosure is directed to a system, comprising: one or more sensors configured to collect biodata associated with a user; and one or more processors in communication with the one or more sensors, the one or more processors configured to: receive the biodata associated with the user; process the biodata using one or more artificial intelligence models to determine an emotional state of the user, wherein the emotional state is a prediction inferred by the processor based on psychophysiological signals derived from the biodata; generate an output, modification, or intervention based at least in part on the inferred emotional state of the user; and provide the output, interaction, or the intervention for presentation to the user.

Another aspect of the present disclosure is directed to a method for generating personalized insight using biodata. The method includes receiving, by a processor, the biodata of a user from one or more sensors; preprocessing, by the processor, the biodata to generate preprocessed data; performing, by the processor, data integration and synchronization on the preprocessed data and linguistic data received from the user to generate fused data; performing, by the processor, data interpolation on the fused data to generate contextualized information and predictive personalized insight; and generating, by the processor, psychographic profiles of the user by performing pattern recognition analysis on the contextualized information and the predictive personalized insight. In some embodiments, the processor is configured to preprocess the biodata by performing one or more of data normalization, data filtering, data transformation, or feature extraction and selection on the biodata. In some embodiments, the processor is configured to perform data interpolation on the fused data by using the fused data as input to an Artificial Intelligence (AI) model.

Another aspect of the present disclosure is directed to a system for performing predictive personalized insight generation. The system includes one or more sensors and a processor in communication with the one or more sensors. The processor is configured to iteratively perform: receive biodata of a user from one or more sensors; preprocess the biodata to generate preprocessed data; correlate the preprocessed data with linguistic data received from the user to generate fused data; and perform data interpolation on the fused data to generate contextualized information and predictive personalized insight using the fused data as input to an Artificial Intelligence (AI) model. In some embodiments, the processor is further configured to iteratively perform: establish baseline data from the preprocessed data and the fused data; and perform anomaly detection on the baseline data to identify and correct detected anomaly. In some embodiments, the processor is further configured to iteratively generate psychographic profiles of the user by performing pattern recognition analysis on the contextualized information and the predictive personalized insight.

Other devices and methods according to embodiments of the present disclosure will be apparent to a person skilled in the art upon review of the following drawings and detailed description. It is intended that all such additional devices and methods be included within this description and within the scope of this disclosure.

### BRIEF DESCRIPTION OF THE DRAWINGS

Non-limiting and non-exhaustive examples are described with reference to the following figures.

FIG. 1 is a block diagram illustrating components of an example system 100 in which biofeedback-enabled AI can be performed, according to embodiments of this disclosure.

FIG. 2 is a diagram illustrating example multidimensional elements defining and/or providing indicators of emotional state.

FIGS. 3A and 3B are flowcharts illustrating methods for generating and using predictive personalized insights, according to embodiments of this disclosure.

FIG. 4 is a diagram illustrating example processing stages of the emotional intelligence engine of FIG. 1.

FIG. 5 is a block diagram illustrating an example of a processing system including hardware and software for implementing embodiments of this disclosure.

### DETAILED DESCRIPTION

The following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. The following detailed description is therefore not to be taken in a limiting sense, and the scope of the present disclosure is defined by the appended claims and their equivalents.

Embodiments of this disclosure relate to emotionally intelligent AI that interfaces with the physical world through real-time biodata (also referred to as “biofeedback”) of a user. For example, linguistic cues (e.g., a verbal or written prompt or other input) may be dynamically contextualized with one or more physiological signals (e.g., heart rate, galvanic skin response, valence, vocal characteristics, facial coding, etc.), thereby allowing the improved emotionally intelligent AI of this disclosure to achieve a more nuanced recognition of emotional states than was possible through static input analysis alone using previous technology. In some embodiments, a self-improving, adaptive loop is employed that continuously readjusts emotion determinations based on real-time biodata. In some scenarios, the availability of biodata may change over time (e.g., based on whether various biosensors are active or in use by a user). Embodiments of the systems and methods of this disclosure adapt to available biodata, such that emotion insights are still generated when biodata is limited and insights are automatically improved and adjusted if/when additional biodata becomes available at another time. For example, active emotion detective algorithms may be regularly or automatically adjusted to align with the available biodata at a given time.

Embodiments of the present disclosure provide an improved technological framework for adaptive decision-making to modulate AI-driven responses for enhanced engagement, credibility, and emotional resonance. For example, in some embodiments, emotional intelligence (EQ) modeling may be incorporated to assess, predict, and respond to both explicit and implicit emotional signals from a user, helping to ensure that AI tools can recognize and dynamically adjust to user moods, stress levels, and psychological states across various contexts.

Embodiments of the present disclosure transform Human-AI interactions by incorporating physiological emotional indicators and non-verbal cues to improve a range of technologies. For example, the systems and methods of this disclosure may provide improved tools for personalized medicine, customer service, mission-critical defense, athletic development and training, mental health, stress reduction and longevity, productivity, and personal coaching, amongst other applications.

By incorporating continuous biodata sensing, embodiments of the systems and methods of this disclosure allow AI tools to self-modulate their response structure, engagement level, and emotional mirroring strategies dynamically. This approach was not previously available and may provide significant technical benefits to various technologies, such as in humanoid robotics and interactive AI. Most existing AI systems operate within fixed data-processing paradigms, where responses are generated based on pre-defined logic trees, statistical probabilities, or reinforcement-based learning. These models lack direct awareness of the user's cognitive and emotional state at any given moment. In contrast, this disclosure provides improved systems and methods whereby AI actively perceives emotional cues based on real-time neurophysiological inputs, interprets these cues, and adjusts operations based on this interpretation.

### Example Biofeedback-Enabled AI System

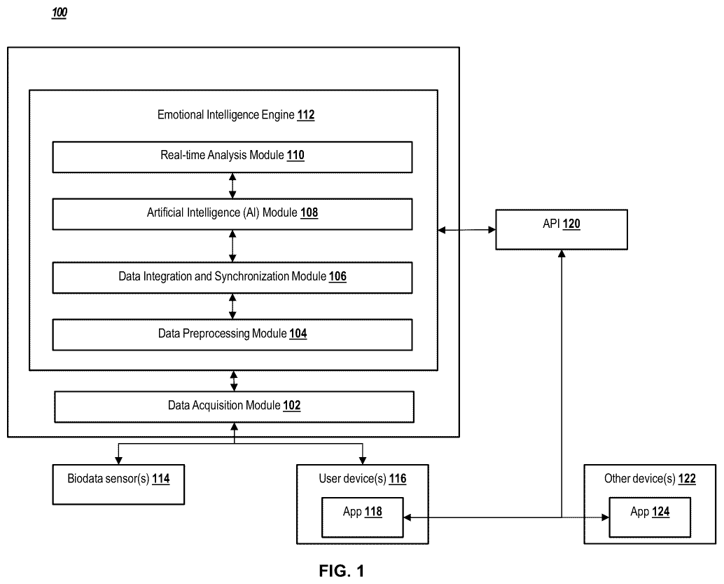

FIG. 1 is a block diagram illustrating components of an example system 100 for implementing the biofeedback-enabled AI of this disclosure. As described in this disclosure, the system 100 allows AI to exhibit adaptive, context-aware, and physiologically informed decision-making. By continuously processing multimodal inputs including (but not limited to) biofeedback, linguistic input, and engagement patterns, the system 100 may self-adjust its credibility, logical structuring, and emotional synchronization dynamically in response to real-time human interaction.

Unlike conventional AI systems that rely on predefined emotional responses or attempt to derive sentiment analysis, the system 100 functions as a complete cognition system that integrates multimodal inputs, recursive self-regulation, and predictive engagement control. Current AI can either be highly logical, appear emotionally responsive via mimicry, or be factually authoritative. However, previous technology fails to balance these three components. In contrast, the system 100 allows AI to “feel” an interaction's trajectory before explicit verbal or environmental signals manifest, mirroring the anticipation process of the human subconscious.

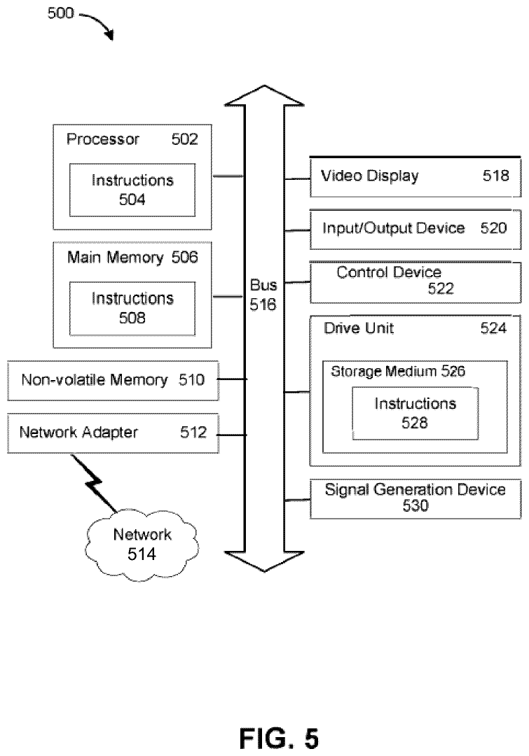

As illustrated in FIG. 1, the system 100 may include components such as, but not limited to, a data acquisition module 102, a data preprocessing module 104, a data integration and synchronization module 106, an AI module 108, and a real-time analysis module 110. In the example of FIG. 1, the data preprocessing module 104, the data integration and synchronization module 106, the AI module 108, and the real-time analysis module 110 together form an emotional intelligence engine 112. In the example of FIG. 1, the emotional intelligence engine 112 uses an API 120 to communicate with applications 118, 124 executed by separate devices 116 and 122, respectively. However, this disclosure contemplates, one or more of these components being combined or separated, such that operations of the emotional intelligence engine 112 and devices 116, 122 may be performed by a single device or additional devices. The various modules 102-110 and devices 116, 122 may be implemented using hardware and/or software, as described in greater detail below with respect to FIG. 5.

Data received by the data acquisition module 102 may include physiological signals, such as neural activity patterns, heart rate variability (HRV) measurements, galvanic skin responses, respiration rates, micro-movement measurements, micro-expression measurements, and the like. The data received may be indicative of an environmental context. For example, data received may include ambient noise recordings, gaze tracking outputs, engagement intensity indications, rates of conversational pacing, and the like. Linguistic and/or interactional data, such as user sentiment analysis, speech cadence, historical engagement patterns, may also be received or determined using the received data.

The data acquisition module 102 is connected to and in communication with one or more biodata sensors 114 and/or user device(s) 116. The data acquisition module 102 generally includes one or more communications interfaces (e.g., the input/output device 520 of FIG. 5) for receiving data from the biodata sensors 114 and/or user devices 116. Biodata sensors 114 and/or user devices 116 facilitate the collection of biodata, contextual data, environmental factors, real-time interactions, and other multimodal data streams for use by the emotional intelligence engine 112. The biodata includes physiological signals or data, such as heart rate, galvanic skin response, valence, vocal characteristics, facial coding, and the like. This information can is used by the emotional intelligence engine 112 to contextualize linguistic cues, as described in greater detail below. Unlike linguistic data, which are static or binary in nature, biodata (also referred to herein as “biofeedback”) are multidimensional and complex.

The biodata sensors 114 and/or user devices 116 are multimodal data sources for the emotional intelligence engine 112. Examples of biodata sensors 114 include, but are not limited to, external sensor arrays, smartwatches, smart rings, smart glasses, smart clothing (e.g., biometric shirts, socks, gloves), heart rate monitors, electrocardiogram (ECG) sensors, electroencephalogram (EEG) sensors, electromyography (EMG) sensors, blood oxygen (SpO₂) sensors, blood glucose monitors, blood pressure monitors, electrodermal activity (EDA) sensors, thermal imaging sensors, infrared sensors, ultraviolet sensors, air quality sensors, accelerometers, gyroscopes, magnetometers, inertial measurement units (IMUs), depth sensors (e.g., LiDAR, structured light, time-of-flight (ToF) cameras), microphones, ultrasonic sensors, standard RGB cameras, infrared cameras, pupil-tracking sensors, eye-tracking sensors, facial recognition cameras, gesture recognition sensors, capacitive touch sensors, piezoelectric sensors, breath analysis sensors, sweat analysis sensors, functional near-infrared spectroscopy (fNIRS) sensors, transcranial electrical stimulation (tES) interfaces, smartphone-based sensors including built-in accelerometers, gyroscopes, magnetometers, GPS tracking, touchscreen pressure sensitivity, voice tone analysis, and camera-based photoplethysmography (PPG) for heart rate tracking, as well as other emerging technologies such as RFID or NFC biometric tags, implantable biochips, smart tattoos incorporating biometric ink, and brain-computer interfaces (BCIs). Examples of user devices 116 include personal computers, smart phones, tablets, voice assistants, and the like. User devices 116 may facilitate the collection of linguistic data (e.g., from a microphone on a mobile phone or wearable device, from analyzing sign language or detecting speech via computer vision from a camera or motion tracking system and/or from inputting means such as virtual keyboard on the mobile phone, etc.) from a user. The linguistic data may be the result of a user interaction detected by the device, such as responding to or providing a prompt through speech, typing, or some other detectable action (e.g., a movement). In some embodiments, a user device 116 may also collect biodata (e.g., from a camera or other sensor(s) of the device 116). As such, in some embodiments, one or more of the biodata sensors 114 are a component of the user device 116 (e.g., a camera, microphone, gyroscope, heart rate sensor, etc. of or coupled to the device 116).

The biodata sensors 114 and/or user devices 116 may collect or provide contextual data, such as whether a user is moving or at rest, where a user is located (e.g., at home, work, etc.), where a user is traveling, etc. This contextual information may be used to improve emotion analysis, since a given user may present different emotional cues based on the context of current sensor data. For instance, if sensor data indicates that the user is in motion and at a location designated as a gymnasium, an elevated heart rate that might otherwise be ascribed to increased stress may instead be associated with exercise. This contextual awareness can improve the performance of downstream applications 118 and/or 124 (as described further with respect to the examples presented below) by providing an emotional context of the user along with any linguistic cues being processed by the applications 118 and/or 124. The biodata sensors 114 and/or user devices 116 may collect or provide environmental factors, such as local weather, temperature, ambient noise level, light level. More generally, the biodata sensors 114 and/or user devices 116 may collect or provide a broad range of multimodal data that can be used to contextualize linguistic data and improve the emotional awareness of AI-based tools, such as applications 118 and/or 124.

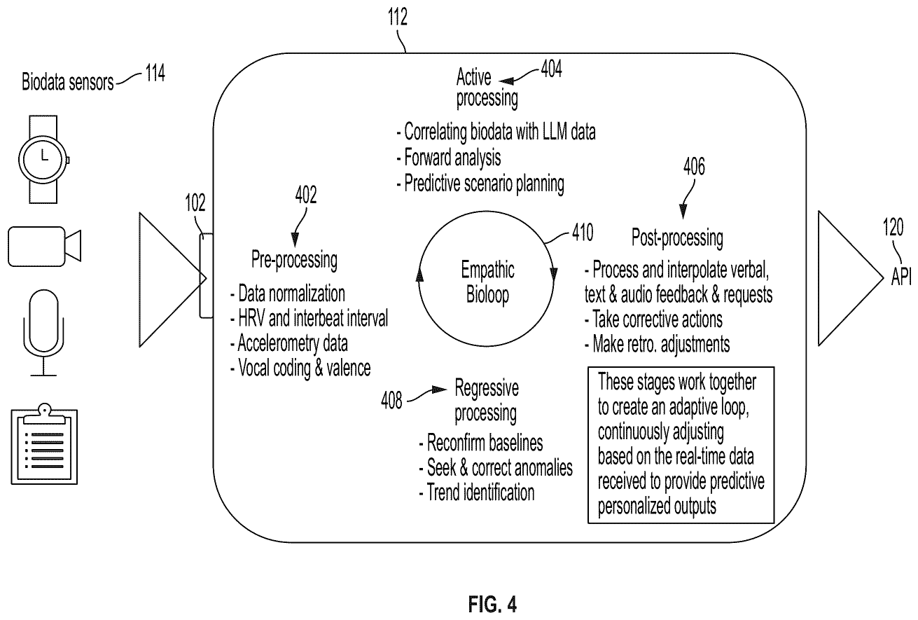

The emotional intelligence engine 112 generally monitors, analyzes, and responds to data from the one or more biodata sensors 114 and/or user device 116. The emotional intelligence engine 112 processes the real-time biodata and detects or anticipates deviations or shifts in user emotional state, which can be used to modify engagement strategies accordingly (e.g., by providing this information to applications 118, 124 providing some emotion-adjusted output, user interaction, and/or intervention). In some embodiments, by leveraging recursive feedback loops (see FIG. 4), the AI continuously refines its interaction style, optimizing trust, clarity, and affective alignment with the user.

In some embodiments, the emotional intelligence engine 112 is executed on a server and communicates with the one or more biodata sensors 114 and/or user devices 116 through a network or a combination of networks (e.g., internet, local area network, wide area network, telephonic network, cellular network, satellite network, etc.). For example, in such embodiments, all or a portion of the modules 102-110 may be implemented on one or more servers that are communicatively coupled to the one or more biodata sensors 114 and/or devices 116, 122 via the network or networks. In other embodiments, one or more operations of the system 100 (e.g., one or more of the modules 102-110) may be implemented on a local device, such as a user device 116 or other device 122.

The data preprocessing module 104 performs one or more preprocessing procedures, such as data normalization, data filtering, data transformation, feature extraction and selection, and the like, on the received data to prepare the data for subsequent data processing. Feature extraction and selection transform the raw biodata into meaningful features that can be understood by the AI module 108. For example, heart rate variability may be determined based on raw heart rate data to help identify a state of excitement of the user using the AI module 108. Audio data that includes speech of the user may be processed to determine one or more vocal properties of the user, such as a tone of speech, rate of speech, etc. Video data may be processed to determine a facial expression or micro-expression of the user. Motion data (e.g., from a gyroscope sensor worn by the user or a motion sensor in a space occupied by the user) may be transformed into a “state of movement” indication (e.g., whether the user is moving or still). This motion data may further be used to determine a rate of movement (e.g., in units of distance per time or on a scale from slow to fast). Electrodermal activity measurements may be processed to determine changes in the user's skin's electrical conductivity. These various properties generated from the sensor data may be used to estimate a valence of the user. Valence generally refers to the positive or negative emotional state of an individual.

The raw and/or processed data may be normalized or otherwise adjusted based on the user. For example, based on previous biodata for the user, different thresholds in heart rate, skin galvanic response, valence, etc. may be set for processing the data and/or extracting features from the data. For instance, for a given user, a baseline heart rate or rhythm may be established over time. This information may be saved in a user profile or may be maintained in an anonymized form. Extracted features may correspond to various indicators of an emotional state of the user, such as a stress level, fear level, happiness level, etc. These features may be used by the other modules 106-110 of the emotional intelligence engine 112 to generate an indication of the user's emotional state, as described further below.

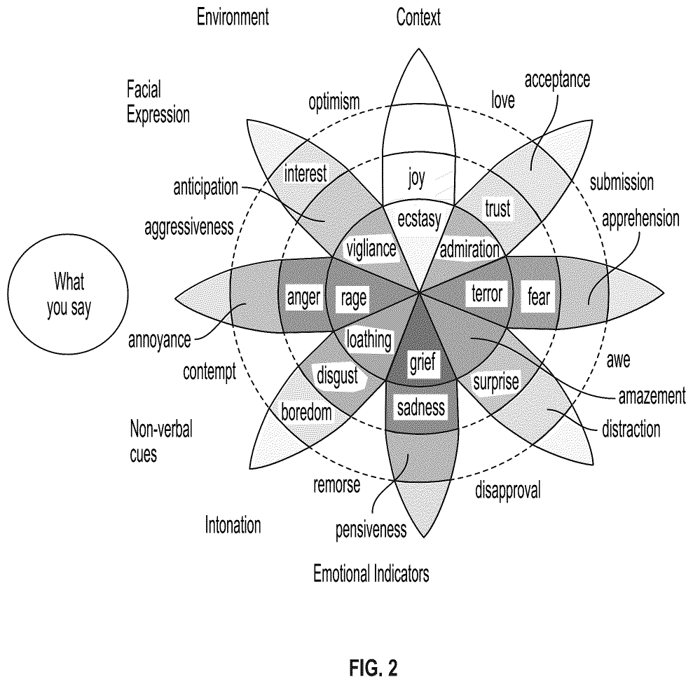

The data integration and synchronization module 106 performs data fusion on the preprocessed data from the data preprocessing module 104 and linguistic data. By evaluating multidimensional real-time biofeedback alongside linguistic data, results may have a higher degree of confidence and accuracy than would be achieved from the pre-processed data and linguistic data viewed alone. Briefly turning to FIG. 2, a diagram is shown illustrating example multidimensional elements that play a role in defining or providing indicators of human emotion. As illustrated in FIG. 2, linguistic data accounts for only a portion of the information associated with the emotional state of an individual. As such, the additional biodata used by the system 100 facilitates a more complete prediction of the user's inferred emotional state.

Returning to FIG. 1, the data integration and synchronization module 106 may integrate multimodal sensor data, including but not limited to physiological, linguistic, visual, auditory, and/or contextual inputs, in any single modality or combination. Since all data types may not always be available (e.g., a wearable health monitor may only be worn intermittently by a given user), the data integration and synchronization module 106 may dynamically adjust system operation based on available data sources. In this way, emotion analysis can still be performed even though the availability of sensor data may change over time.

The AI module 108 utilizes one or more trained AI models to interpret or interpolate the fused data generated by the data integration and synchronization module 106 to contextualize the fused data and generate predictive personalized insight. The one or more AI models may include, but are not limited to, convolutional neural networks (CNNs), recurrent neural networks (RNNs), deep RNNs (DRNNs), transformer models, generative adversarial networks (GANs), autoencoders, reinforcement learning models such as Q-learning networks (QNs) and deep Q-learning networks (DQNs), and self-supervised learning models. RNNs may include long short-term memory (LSTM) networks, gated recurrent units (GRUs), and bidirectional RNNs (BiRNNs).

Transformer-based architectures may include variants such as BERT, GPT, Vision Transformers (ViTs), and other attention-based models. In some embodiments, the one or more AI models may include a large multimodal language model that works with different types of linguistic input data, such as text, images, audio, video, etc., which can be used in generating the fused data generated by the data integration and synchronization module 106. In some embodiments, the AI module 108 generates both contextualized information and predictive personalized insight. The AI module 108 may incorporate a self-evolving AI model that dynamically adjusts its structure, parameters, and learning pathways over time, optimizing insights and responses beyond pre-trained datasets. In some embodiments, the AI module 108 incorporates explainable AI (XAI) methodologies to provide transparent reasoning behind AI-generated insights and recommendations. In some embodiments, the AI module 108 includes system parameters and/or AI model weights that are dynamically based on environmental and user-specific factors to maximize personalization and reliability. In some embodiments, the AI module 108 includes a secure, privacy-enhanced AI engine that ensures compliance with biometric data regulations (e.g., to improve data security and regulatory compliance).

The AI module 108 may include a structured cognition model (described further below) that facilitates operations in dynamic human environments, where engagement, trust, and logical coherence should be fluidly self-regulated. The structured cognition model may allow artificial intelligence to develop adaptive intuition, such that decision-making is refined by subconscious-level physiological cues rather than static rules or purely probabilistic outputs. In some embodiments, the AI cognition model facilitates physiologically informed decision-making. The AI cognition model integrates real-time physiological data streams to modulate cognitive and engagement strategies dynamically. The AI cognition model may allow cross-modal reasoning adjustment system that shifts credibility, logic, and emotional engagement based on live biodata interpretation.

The real-time analysis module 110 uses the information from the previous modules 104-108 to dynamically generate and refine psychographic, physiological, and/or cognitive profiles of the user by applying pattern recognition, anomaly detection, and trend analysis on the contextualized information. The real-time analysis module 110 may generate predictive personalized insights. These outputs of the real-time analysis module 110 may correspond to an estimation or prediction of an inferred emotional state of the user. An adaptive feedback system may be employed that continuously refines dynamic recommendations or other outputs that are available via the application programming interface (API) 120, as described further below. This feedback system may use a recursive deep learning architecture that optimizes user experience through continuous, real-time biodata analysis, ensuring system responsiveness remains within real-time operational constraints to facilitate seamless user interaction. An example of such a feedback-based approach is described below with respect to FIG. 4.

The profile generated by the real-time analysis module 110 may include an emotional context or state of the user (e.g., a level of happiness, stress, fear, anger, etc.). This information can be provided to the API 120, which makes the profile available to applications 118, 124. The API 120 may be agnostic to the large language model (LLM) used to interpret language inputs. In the example of FIG. 1, application 118 is executed on the user device 116, while application 124 is executed on the other device 122. The other device 122 may be a component of a “smart” system such as a mobile phone, a vehicle, a smart home, a workspace, a lighting system, a sound system, a gaming system, or a virtual reality/augmented reality system. The other device 122 may be a humanoid robot. Using information provided by API 120, applications 118 and/or 124 may allow multimodal feedback mechanisms, including auditory, haptic, and/or visual notifications, to enhance user interaction and system adaptability.

In some embodiments, the emotional intelligence engine 112 integrates the inputs received at the data acquisition module 102 and uses AI to adaptively perform (1) a trust calibration, (2) contextual reasoning, and (3) emotional adaptation. The resulting emotion insights or data (e.g., indicating various emotion levels or other metrics of user emotion) may be used by applications 118, 124, as described with respect to the various examples presented below.

For trust calibration, a user credibility weighting may be determined based at least in part on the received biodata and/or using user interaction history. For example, the biodata sensors 114 may continuously track eye-tracking fixation, pupil dilation, skin conductance, and/or vocal modulations to infer trust dynamics and recalibrate response tone accordingly. A recursive credibility feedback loop may be used to ensure progressive trust reinforcement or correction of misalignment over sustained interactions with the user. In this way, physiological confidence signals, such as steady gaze fixation, micro-expression tracking, and heart rate stabilization patterns, may be used to continuously monitor the credibility level of the user. If the credibility level falls below a threshold value, the system 100 may determine that the user is not credible (e.g., is being dishonest in some way), and interactions with devices 116 and/or 122 using information from the emotional intelligence engine 112 may be adjusted accordingly. For example, access to information may be restricted for the untrusted user. In other embodiments, the credibility weighting corresponds to an extent to which the user appears to trust the output, interaction, or intervention provided by the application 118, 124. In such embodiments, actions of the applications 118, 124 may be proactively adjusted to improve the user's trust in the application 118, 124.

In some embodiments, the system 100 determines a cognitive load of the user based on the biodata and adapts the complexity of information provided to the user (e.g., via a device 116, 122) based on the cognitive load. For example, information complexity may be decreased if the user's cognitive load is above a threshold. In this way, the user's cognitive load can be better managed. The emotional intelligence engine 112 may adapt logical structuring of information presented to the user and/or the information's complexity based on real-time cognitive load indicators found in the biodata, such as neural oscillation patterns, reaction latency, and attentional shifts. If the emotion data is being used to provide a chatbot or other interaction with the user, real-time optimization of conversational structure, pacing, and/or depth of reasoning may be performed to align with any inferred cognitive fatigue or the user's current level of engagement intensity. Adaptive prioritization of sequential reasoning pathways or simplified conceptual explanations may be presented based on observed comprehension markers.

In some embodiment, emotional adaptation may be performed via predictive interaction management. For example, an engagement approach employed by an application 118, 124 used to communicate with the user may be modified based on the user's current emotional state. For instance, if a voice assistant is provided by the application 118, 124 that provides some audible linguistic cue, such as a question or response, this artificial speech may be dynamically modulated, such as by adjusting the artificial voice's cadence and/or tone or by mirroring an affect of the user, to improve rapport with the user and better align the artificial voice with the user's emotional state. These adjustments may be performed to improve a user's trust in the information provided by the application 118, 124. In some embodiments, predictive emotional inference algorithms are used to anticipate shifts in the user's emotional state and adjust conversational strategy preemptively.

In some embodiments, the system 100 (e.g., the emotional intelligence engine 112 and/or a device 116, 122) generates linguistic cues that are presented to the user. For example, the linguistic cues may be words in the form of a question, response, or statement presented to the user either in text or through audio. The system 100 can receive a response to the linguistic cue, such as a comment on the statement or a response to a question. The reasoning algorithm that facilitates this communication may be adjusted based on the user's emotional state (e.g., at the time of the response or over a recent time interval). The updated reasoning model changes properties of subsequent linguistic cues to account for the user's emotional state. For example, if the linguistic cues are intended to persuade the user to agree with a given point of view, and the biodata indicates the user is stressed or unhappy, an alternative line of reasoning may be presented in an attempt to move away from the distressing statements previously presented and calm the user. Recursive emotional tuning mechanisms may be used to optimize conversational outcomes over time, for example, based on observed stress reduction, affirmation signals, and/or dissonance correction patterns.

In some embodiments, the emotional intelligence engine 112 uses a feedback mechanism to improve insights over time. For example, the emotional intelligence engine 112 may employ a recursive, multi-stage adaptive feedback mechanism (see FIG. 4) that continuously refines predictions and system responses based on real-time biodata variations, user interactions, and detected anomalies. This helps to provide continuous self-optimization and personalized decision-making across multiple contexts.

While the emotional intelligence engine 112 is primarily described as providing real-time or near real-time emotion insights, the emotional intelligence engine 112 may also or alternatively construct multi-dimensional cognitive and behavioral models or profiles for the user. These models may be used to analyze longitudinal trends in biodata and behavioral responses to predict long-term mental, emotional, and/or cognitive states of the user.

In some embodiments, the emotional intelligence engine 112 facilitates socially dynamic feedback. For example, the emotional intelligence engine 112 may dynamically adjust insights and interactions based on biodata specific to the user as well as group dynamics, environmental conditions, and/or emotional/physiological states of other users to improve social, professional, and/or contextual engagement. For example, the emotional intelligence engine 112 may receive biodata from multiple users (e.g., where biodata sensors 114 provide data for multiple users interacting in a space). Emotional insights for a given user generated by the emotional intelligence engine 112 may account not only for the biodata of that user but also biodata, or the resulting emotional insights, of the other interacting users.

In some embodiments, emotion insights from the emotional intelligence engine 112 are used to perform predictive interventions. These interventions may be implemented by the emotional intelligence engine 112 or another device (e.g., a user device 116 and/or device 122) to provide an automated intervention that may improve the emotional state of a user or provide other technological benefits. For example, emotion insights generated by the emotional intelligence engine 112 may be used to preemptively adjust environmental factors, device settings, or digital interactions based on predictive emotional and cognitive state analysis. For instance, emotion insights generated by the emotional intelligence engine 112 may be used to trigger automated adaptive interventions before distress occurs, including but not limited to adjusting sensory stimuli (e.g., modifying screen brightness, sound levels, music tempo, room temperature, ambient lighting, haptic feedback), modulating digital engagement (e.g., dynamically altering AI conversational tone, pacing, response complexity, or UI interactions), and/or initiating behavioral guidance (e.g., recommending breaks, suggesting alternate activities, providing relaxation cues). If the emotional intelligence engine 112 determines that an unwanted emotional state is likely to occur in the near future, an intervention may be preemptively implemented.

As another example, the emotion insights may be used to perform proactive adjustments in environmental settings, such as room or seat temperature, audio level settings, ventilation settings, brightness level settings, mood lighting settings, fragrance emission settings, etc. In some embodiments, the emotion insights are used to select alternate navigation routes based on context such as driver stress levels. For example, a route with less traffic may be selected and presented to the user to proactively reduce stress exposure of the user. In these embodiments, the API 120 may provide the stress level indication to the user device 116, and a navigation application (e.g., corresponding to application 118 in this example scenario) may be configured to use the stress level to adjust route selection.

In another example embodiment, the emotion insights may be used to autonomously adapt interactive systems and physical environments, including but not limited to vehicle settings, smart home adjustments, workspace configurations, lighting and/or sound ambiance, and virtual/augmented reality parameters, to mitigate neurocognitive or physiological strain in real time. For example, if such a strain is detected or predicted, system settings may be automatically adjusted to avoid increased strain on the user. The system settings may be continuously or regularly updated based on the current and/or predicted emotional state of the user.

In some embodiments, the system 100 (e.g., the emotional intelligence engine 112 and/or a device 116, 122), determines a longitudinal trend in the biodata over a period of time and detects a deviation, such as a negative shift, in the emotional state of the user. The deviation may correspond to an unwanted change in the user's emotional state, such as an increase in stress, disengagement, and/or cognitive fatigue. In response, the system 100 provides a proactive intervention for addressing the negative shift in the emotional state of the user. The shifts in emotional state may be dynamically predicted. This approach may be used to detect and monitor engagement decline, cognitive fatigue, and/or physiological stress and trigger adaptive digital, environmental, and/or behavioral interventions, as described with respect to the examples above, before performance or well-being is impacted. The timing and efficacy of these interventions may be continuously or regularly refined using iterative learning from user responses, biodata patterns, and/or environmental conditions.

In some embodiments, the system 100 supports distributed multi-agent collaboration (such as through an AI Mesh Network formed between multiple devices forming the emotional intelligence engine 112 and optional the biodata sensors 114 and/or devices 116, 122), allowing nodes across multiple devices and users to perform various tasks. This may result, for example, in improved resource utilization and performance. For example, components of the system 100 may collaborate, share biodata insights, and dynamically adjust shared environments or interactions including real-time multi-user coordination, stress and fatigue tracking, adaptive workload balancing, and mediation to improve user engagement, safety, and productivity across workgroups, teams, and social networks. The system 100 may optimize team collaboration by cross-referencing biodata across multiple users. The system 100 may allow synchronized adaptive responses in shared spaces, such as by adjusting room lighting, soundscapes, or other environment characteristics based on collective biodata trends.

In some embodiments, the system includes one or more neuroadaptive digital interfaces. For example, the user device 116 and/or other device 122 may include a neuroadaptive digital interface, such as a display, speaker, a haptic device, lighting, an augmented reality display, a virtual reality display, etc., that allows an output provided to the user to be adapted based on the emotional state of the user. In such cases, user interfaces, augmented/virtual reality environments, haptic feedback, and/or environmental conditions may be modified based on cognitive and emotional state analysis of a user. Furthermore, real-time conversational and interactive AI-driven be adapted based on this analysis. For example, conversational and interactive AI may perform context-aware voice modulation, live conversational tone adjustments, real-time response personalization, and proactive engagement strategies to maintain user engagement and reduce interaction fatigue. Various features of a user interface, such as visual complexity, color schemes, UI responsiveness, and interaction dynamics, may be adjusted based on user stress, fatigue, or cognitive overload.

In some embodiments, the system 100 incorporates cross-device, cross-context adaptability. For example, the system 100 may provide seamless user adaptation across multiple platforms, devices, and usage environments without loss of personalized context. For example, the API 120 may be configured to communicate with a variety of devices. In this way, the emotional intelligence engine 112 can reliably maintain emotional state information for a user as the user moves between devices and “hand-off” the emotional state information to different devices, such that the new devices can immediately and reliably incorporate this information (e.g., to provide user-specific interactions and/or interventions, as described above and elsewhere in this disclosure). The transition between devices, which may be AI-assisted, allows transition of engagement levels, emotional tone, and task history across different interaction points (e.g., phone, tablet, vehicle, workspace, home automation).

In some embodiments, the system 100 allows AI-driven cognitive load management. For example, the system 100 may be used to detect mental fatigue in real time and/or improve interactions to reduce information overload. For example, workflows, notifications, and/or digital interactions may be dynamically reconfigured to provide cognitive load balancing. For instance, workflows, task prioritization, and/or attention-aware notifications may be restructured to help ensure that information is presented at the optimal time and in the most cognitively efficient format based on user engagement or emotion levels.

In some embodiments, the system 100 integrates a hierarchical framework in which multi-layered AI decision-making is performed to dynamically prioritize and rebalance logical, emotional, and sensory inputs in real time based on user interaction history, environmental context, and physiological state. For example, recursive machine learning, multi-objective optimization models, predictive analytics, anomaly detection, and/or reinforcement learning may be used to continuously refine engagement strategies, real-time response modulation, and intervention timing.

In some embodiments, the system 100 implements improved data security processes to protect sensitive biodata or other user information. For example, the emotional intelligence engine 112 may use homomorphic encryption, differential privacy techniques, and/or secure multi-party computation to ensure confidential AI-driven biodata processing without exposing raw user data. Federated learning frameworks may be used that comply with industry privacy standards, including but not limited to HIPAA, GDPR, and emerging biometric security regulations, to prevent unauthorized access or misuse of sensitive physiological and behavioral insights. Example embodiments protect and de-identify healthcare data or biodata subject to Health Insurance Portability and Accountability Act of 1996 (HIPAA) by transforming personal identifiable information (PII) into tokens or masking PII to protect healthcare/biodata of users.

### Integration with Example Applications

Still referring to FIG. 1, a range of applications 118, 124 can provide improved functionality using emotional intelligence information provided via API 120. Examples of such applications 118, 124 are described below.

Performance Optimization & Training Applications: Applications 118, 124 for real-time cognitive load assessment, stress mitigation, and/or athletic performance enhancement (e.g., providing precision training recommendations, recovery insights, and/or adaptive coaching based on real-time physiological metrics) may be improved by the emotion insights generated by the emotional intelligence engine 112. As another example, applications 118, 124 for training and optimizing reaction times in high-stakes professions (e.g., pilots, military personnel, first responders, surgeons) may be improved using the emotion data provided by the emotional intelligence engine 112. As yet another example, AI-assisted meditation and mindfulness applications may be improved using the emotion data provided by the emotional intelligence engine 112. Each of these example applications 118, 124 may be improved by tailoring trainings or prescribed activities based on the real-time emotional state of the user and/or a record of the user's emotional state. For example, an application 118, 124 for meditation may tune meditation instructions in real time to attempt to decrease the user's stress into a target zone. Likewise, an application 118, 124 used for exercise, athletic training, or other skill training may adjust instructions for the exercise or training to make the user's experience less stressful or more enjoyable, such that the user is more likely to continue the training over time with greater chance of long-term success.

Digital and/or Humanoid Companionship Applications: Applications 118, 124 may use emotion data from the emotional intelligence engine 112 to provide emotionally adaptive conversational AI for therapy, coaching, and/or personal assistants. These tools may dynamically adjust engagement style, speech modulation, response personalization, and/or contextual empathy based on real-time physiological and behavioral cues determined using the emotion data from the emotional intelligence engine 112. Other examples of application 118, 124 that may benefit from the emotion data generated by the emotional intelligence engine 112 include AI-driven grief and trauma support chat interfaces, context-aware virtual companions for elderly or socially isolated individuals, and AI-enhanced memory recall assistance for neurodivergent or cognitively impaired users.

Human-Robot Interaction Applications: Applications 118, 124 may use emotion data from the emotional intelligence engine 112 to optimize or improve robotic and virtual agent interactions using physiological, behavioral, and contextual adaptation mechanisms to facilitate real-time responsiveness, personalized engagement, and predictive interaction modeling. The emotion data from emotional intelligence engine 112 may facilitate real-time robotic adaptation, allowing AI-driven humanoid assistants and robotic caregivers to modify gesture dynamics, micro-expressions, speech cadence, breathing pattern mirroring, and/or real-time movement fluidity based on continuous biodata input/feedback. This may enhance naturalistic interactions, emotional bonding, synthetic empathy, and engagement quality.

Workplace Productivity Applications: Applications 118, 124 may use emotion data from the emotional intelligence engine 112 to facilitate real-time well-being assessment, cognitive fatigue prediction, stress detection, adaptive workload balancing, and/or burnout prevention strategies. For example, the emotion data from the emotional intelligence engine 112 may be used to dynamically adjust task sequencing, notification prioritization, and workflow structuring based on real-time and historical biometric patterns. An application 118, 124 may allow adaptive meeting intelligence whereby the application 118, 124 uses emotion data to adjust meeting pace, agenda sequencing, and/or visual/audio stimuli based on engagement levels determined using the emotion data. As another example, real-time AI-based team collaboration monitoring may be performed to detect and monitor stress across workgroups and redistribute workload in response. For instance, the emotional intelligence engine 112 may receive biodata for multiple individuals that form a group. This group biodata may be processed by the emotional intelligence engine 112, as described above, to predict an inferred emotional state for each induvial of the group (or a subset of the members of the group). A group output, modification, or intervention is then determined to provide to the user via the application 118, 124 (e.g., to adjust meeting pace, agenda sequencing, and/or visual/audio stimuli or redistribute workload to group members).

Security and Authentication Applications: Applications 118, 124 may use emotion data from the emotional intelligence engine 112 for improved data security and user authentication. For example, biometric-driven continuous authentication may be performed based on physiological state changes, cognitive load patterns, and/or unique “emotional signatures” determined by the emotional intelligence engine 112. For example, an application 118, 124 may use emotion data for real-time deception detection via stress-induced micro-expressions, physiological irregularities, and/or cognitive coherence tracking to identify fraud, insider threats, and/or unauthorized AI manipulation. An example application 118, 124 may perform adaptive access control, fraud detection, and/or identity verification based on real-time behavioral and/or physiological markers. Emotion-detection for fraud prevention may be employed in banking or other security-sensitive environments. An example application 118, 124 may perform AI-powered continuous multi-factor authentication that adapts based on user stress, fatigue, and physiological anomalies. An example application 118, 124 may perform continuous tracking of physiological consistency, emotional stability, cognitive coherence, and/or stress-induced micro-expressions to detect deception, unauthorized AI manipulation, neurological decline, and/or real-time behavioral anomalies.

Smart Home & IoT Applications: In some embodiments, the other device 122 is part of a system for home automation or automation of another space that adjusts climate, lighting, and/or acoustics based on biodata trends, sleep cycles, and/or cognitive load detection using information from the emotional intelligence engine 112. For example, an adaptive smart kitchen assistant may modify meal planning, portion sizes, and/or nutritional recommendations based on stress, activity level, and/or other biodata insights from the emotional intelligence engine 112. Automated family-wide cognitive wellness tracking may be performed that can detect changes in collective stress patterns within a household and adjust environments (e.g., lighting, sound, air temperature, etc.) accordingly.

Education and Learning Applications: Applications 118, 124 may use emotion data from the emotional intelligence engine 112 to provide personalized learning environments that adjust curriculum difficulty, engagement pacing, and/or multimodal content delivery based on real-time cognitive load, stress levels, and/or fatigue patterns. For example, the application 118, 124 may be an educational application that provides AI-enabled tutoring and/or exam preparation assistance that improves timing and question delivery and/or provides adaptive explanations based on student engagement and/or emotional state. Emotional state may be used as a proxy for estimating comprehension level and performing comprehension tracking. For example, real-time attention and frustration detection may be performed to dynamically modify lesson structures and reinforcement activities to maintain peak cognitive engagement and receptivity. The applications 118, 124 for learning may be for automated learning (e.g., without a human teacher), online learning (e.g., with a remote human teacher), and/or in-person learning.

Retail and Consumer Experience Applications: Applications 118, 124 may use emotion data from the emotional intelligence engine 112 to provide adaptive shopping interfaces that modify product recommendations, pricing strategies, and/or in-store/online experiences based on real-time biodata analysis. For example, real-time customer sentiment monitoring may be used to adjusts sales recommendations or service approaches in retail and hospitality industries. For instance, an application 118, 124 may implement these adaptations in an online store, or the adaptations may be recommended for an in-person store. The emotion data may be used to provide adaptive virtual reality/augmented reality (VR/AR)-powered retail experiences that personalize in-store navigation, lighting, and/or other sensory cues to improve customer comfort and engagement.

Customer Service: Applications 118, 124 may use emotion data from the emotional intelligence engine 112 to provide customer service tools with improved compassion. For example, an automated chatbot may use emotional insights from the emotional intelligence engine 112 to adjust interactions to reduce user stress and/or frustration. As another example, an application 118, 124 may provide insights into a user's emotional state to a human customer service agent, such that the agent is aware of the customer's emotional state.

Brain-Computer Interfaces (BCI) & Emotionally-aware Neural Adaptation Applications: Applications 118, 124 may use emotion data from the emotional intelligence engine 112 to facilitate real-time integration of physiological biodata, neural signals, and/or bioelectrical patterns to infer cognitive state, emotional intent, and subconscious responses, moving towards more seamless non-verbal interaction between humans and technology. For example, one of the biodata sensors 114 may be a brain-computer interface (BCI) device that can measure neural oscillations of a user and provide an output to another device (e.g., one of the devices 116, 122) based on the neural oscillations. The emotional intelligence engine 112 may use multimodal AI processing of biodata, such as heart rate, heart rate variability, galvanic skin response, vocal characteristics, respiratory patterns, facial micro-expressions, as well as the neural oscillations measured by the BCI device, to dynamically map emotion-driven intent, predict affective states, and/or refine BCI-facilitated interpersonal and human-computer interactions. These applications 118, 124 may be used for emotion-aware medical prosthetics, cognitive state-responsive gaming and metaverse experiences, neural-enhanced communication interfaces, AI-assisted rehabilitation, and/or adaptive biofeedback-driven environments.

Adaptive AI Applications for Digital Personas & Virtual Identity: Applications 118, 124 may use emotion data from the emotional intelligence engine 112 to provide emotion-adaptive digital clones, avatars, and/or AI-enhanced personas that can evolve based on user interactions, preferences, emotional engagement, and/or real-time biodata. Such applications 118, 124 may be used to provide AI-generated influencers, virtual assistants, metaverse identity systems, and/or memory-enhanced virtual personas that retain and respond to emotional context.

Adaptive Art & Media Creation/Generation Applications: Applications 118, 124 may use emotion data from the emotional intelligence engine 112 to dynamically generate or modify music, artwork, literature, and/or video content in response to user physiological and emotional signals, enabling personalized art therapy, AI-composed soundtracks, adaptive artwork, and dynamically evolving media experiences tailored to engagement levels or emotional state for both individual and group (aggregated) consumption.

Adaptive Gaming & eSports Applications: Applications 118, 124 may use emotion data from the emotional intelligence engine 112 for real-time gaming adaptation. For example, an application 118, 124 that is a gaming application may modulate gameplay difficulty, non-player character (NPC) behavior, and/or in-game environmental characteristics/complexity based on player physiological and cognitive state. In this way, engagement, skill-building, and performance may be improved in a range of game types, including role playing games (RPGs), eSports, VR/AR games, and virtual training simulations.

Smart Architecture & “Bioreactive” Environment Applications: Applications 118, 124 may use emotion data from the emotional intelligence engine 112 to dynamically adjust environmental conditions, workspace layouts, and/or other environmental factors based on collective biodata signals to enhance productivity, safety, and well-being. Such applications 118, 124 may be deployed in smart cities, hospitals, and other high-performance workplaces, including adaptive office layouts that respond to team stress levels, as an example.

Applications for Adaptive Wearable Technology: Applications 118, 124 may use emotion data from the emotional intelligence engine 112 to provide software-connected smart textiles and wearable devices with features such as temperature regulation, hydration reminders, and/or biomechanical support that are adjusted in response to real-time biometric feedback. In this way, comfort and performance may be improved and controlled based on a wearer's emotional and physiological state. The textiles may be used for extreme climate protection, athletic wear, high-stress environments, military gear, and/or medical monitoring.

Sleep Optimization & Restorative Environment Applications: Applications 118, 124 may use emotion data from the emotional intelligence engine 112 to monitor and enhance sleep conditions by dynamically adjusting bedding, room temperature, soundscapes, and/or light exposure in response to physiological signals, supporting smart beds, adaptive relaxation/meditation therapy, and high-performance sleep enhancement.

Personalized Communication & Emotion-aware Messaging Applications: Applications 118, 124 may use emotion data from the emotional intelligence engine 112 to analyze linguistic tone, inferred user sentiment, and physiological cues to optimize message delivery, engagement timing, and interpersonal interactions, for example, for corporate communication, conflict de-escalation, and dynamic real-time negotiation assistance.

Child, Elderly, & Caregiver Monitoring Applications: Applications 118, 124 may use emotion data from the emotional intelligence engine 112 to provide real-time monitoring that interprets biometric data, sleep cycles, movement patterns, vocalizations, facial expressions, and behavioral cues to assess emotional state, stress levels, and cognitive engagement, providing adaptive assistance for parents, caregivers, and healthcare professionals. For example, an application 124 may control a device 122 that is a smart baby monitor that detects distress. The application 118, 124 may be a parenting software tool that adjusts engagement strategies based on infant emotional states. An example application 118, 124 may be a part of a biofeedback-driven healthcare tool that detects discomfort or early signs of illness. An example application 118, 124 may be part of a tool that assesses loneliness, cognitive decline, and/or emotional distress. An example application 118, 124 may provide real-time anomaly detection for fall risk and autonomic health events. An example application 118, 124 may be AI-assisted caregiving software (e.g., for humanoid robots capable of responding to emotional and physiological cues in real time). An example application 118, 124 may be part of an adaptive in-home monitoring system for individuals needing special care, enabling proactive emotional support, safety interventions, and/or enhanced well-being.

Automotive Safety and Experience Applications: Applications 118, 124 may use emotion data from the emotional intelligence engine 112 to use driver stress, fatigue, cognitive overload, and/or emotional distraction levels to trigger adaptive in-cabin interventions, safety notifications, and/or other automated adjustments for increased driver alertness and/or comfort. Personalized driving profiles may be generated that can be used to predict and adjust vehicle behaviors (e.g., steering, acceleration, braking) based on cognitive load and fatigue tracking. Multimodal biometric-based alertness verification may be used to monitor the state of high-risk professional drivers. An example application 118, 124 provides an autonomous vehicle cabin experience with in-cabin adaptive environment modulation, multimodal interaction, and real-time passenger state optimization. Another example application 118, 124 provides personalized entertainment adaptation, dynamically adjusting streaming video, music, gaming, and/or other interactive media experiences based on user preferences, cognitive load, and/or emotional state. Another example application 118, 124 provides adaptive content curation, selecting or modifying media recommendations such as adjusting playback speed, altering audio volume, filtering high-intensity content, or dynamically altering engagement pacing in response to detected fatigue, stress, or attention levels. Another example application 118, 124 provides immersive in-cabin VR/AR experiences, integrating biodata-driven adjustments such as motion compensation, field-of-view adaptation to dynamically alter visual or audio stimuli. Personalized sensory feedback may be used to enhance user experience.

Another example application 118, 124 provides context-aware digital engagement, where AI interfaces provide adaptive conversation, virtual companionship, guided interactions, and/or automated task assistance, responding in real time to passenger preferences and physiological states. Another example application 118, 124 provides dynamic environmental adjustments, modifying seat ergonomics, ambient lighting, soundscapes, temperature, and/or haptic feedback to enhance comfort, relaxation, or engagement during transit while synchronizing with real-time biodata signals. Another example application 118, 124 provides predictive environments based on passenger needs, dynamically adjusting cabin conditions, entertainment preferences, and travel recommendations based on real-time biodata, stress levels, and mood, enabling biometric-based adaptive ride-sharing, personalized autonomous vehicle experiences, and mobility services. Another example application 118, 124 provides autonomous in-cabin workspaces, where AI adapts in real-time to optimize productivity, ergonomics, and focus within mobile work environments, adjusting digital workspace interfaces, noise cancellation, and/or interaction timing.

The system 100 of FIG. 1 provides a number of technological improvements over previous technology. Previous AI tools primarily function as reactive systems, generating outputs only when explicitly prompted by user queries or environmental inputs. System 100 shifts AI cognition into a predictive paradigm, where emotional state transitions, cognitive fatigue, and engagement fluctuations may be anticipated before they manifest behaviorally. By transitioning AI cognition from a reactive response generation to a proactive engagement optimization, embodiments of the system 100 provide an improved approach to AI cognition that more closely resembles the way humans instinctively adjust in social interactions. For example, anticipatory emotional modulation may be performed, whereby the system 100 preemptively shifts tone, pacing, or reasoning complexity based on subtle physiological precursors of emotional state changes. As another example, proactive engagement control may be performed using system 100. Instead of responding only when prompted, the system 100 can be configured to subtly prompt a user for improved engagement by detecting user hesitation, stress buildup, and/or disengagement markers. As yet another example, cognitive load balancing can be performed using the system 100. For example, information density and logical structuring can be automatically adjusted based on user fatigue levels and attentional shifts.

The system 100 may also provide more ethical AI. Previous AI systems lack a built-in framework for assessing ethical implications in real time. Instead, these systems rely on hard-coded constraints, post-processing filters, or external compliance mechanisms. In contrast, the system 100 may autonomously modulate its communication strategy to align with social, psychological, and ethical expectations rather than merely being optimized for task completion or response accuracy. Ethical reasoning may be included in the system's cognition model, for example, by weighing the implications of trust versus factual accuracy. The system 100 may dynamically decides when to emphasize confidence versus when to express uncertainty based on user trust signals. The system 100 may evaluate emotional impact in real time. For example, the system 100 may determine whether a response could cause distress, frustration, or unintended emotional reactions and adjust interactions accordingly. In this way, the system 100 may be configured to improve interactions in a manner that prioritizes or at least considers user well-being. The system 100 can be tuned to help ensure that engagement fosters understanding, clarity, and trust-building rather than simple response efficiency.

### Example Methods of Operation

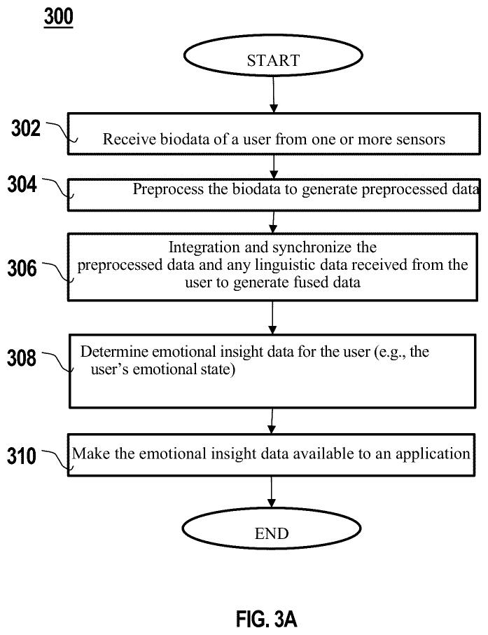

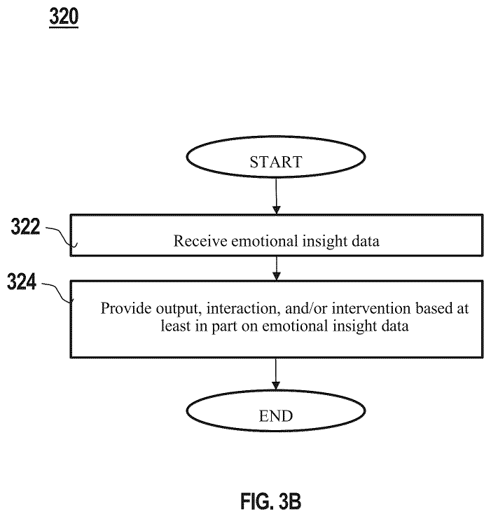

FIGS. 3A and 3B illustrate example methods of generating a personalized emotional insight (e.g., a user's emotional state) (FIG. 3A) and using the emotional insight to personalize an output, interaction, or intervention provided by a device (FIG. 3B). In some embodiments, the method 300 of FIG. 3A is performed by a first device (e.g., a computer or server executing the emotional intelligence engine 112 of FIG. 1), while the method 320 of FIG. 3B is performed by a separate device (e.g., a device 116, 122 of FIG. 1). However, the methods of FIGS. 3A and 3B may be performed by the same device or multiple devices (e.g., that form a computational network). As illustrated in FIG. 3A, method 300 may begin by receiving biodata of a user from one or more sensors at step 302. At step 304, the biodata is preprocessed to generated preprocessed data, for example, through performance of at least one of data normalization, data filtering, data transformation, and feature extraction and selection. If the biodata includes multimodal data with a number of different biometric signals (e.g., HRV, micro-expressions, vocal tone, etc.) of the user, the multimodal data may be preprocessed to generate preprocessed multimodal data.

The method 300 may then proceed to step 306 where data integration and synchronization are performed on the preprocessed data and any linguistic data received from the user to generate fused data. Multimodal data may also be synchronized to generate the fused data (e.g., by aligning timestamps of the multimodal data from different data sources). In some embodiments, the linguistic data, if any, may be received and processed at a different time.

Data interpolation and, optionally, predictive modeling, may then be performed on the fused data to generate emotional insight data at step 308. For example, the user's emotional state may be determined and/or a predicted future emotional state of the user may be determined. Data interpolation and predictive modeling are performed on the fused data to generate a predicted emotional state of the user using the fused data as an input to one or more artificial intelligence models (e.g., of the AI module 108 of FIG. 1). User profiles, which may include psychographic, physiological, and cognitive characteristics of the user, may be generated or updated for the user using the information from step 308. For example, pattern recognition analysis may be performed on the emotional insight data from step 308 to generate or update the user profile. In some embodiments, the user's predicted emotional state may be iteratively updated over time using a multi-stage feedback mechanism. (see FIG. 4). In some embodiments, a long-term emotional state of the user may be predicted using the predicted emotional states that are iteratively updated over time.

At step 310, the emotional insight data is made available to other devices and/or applications. For example, the emotional insight data may be passed to or otherwise made accessible to an API, such as API 120 of FIG. 1.

FIG. 3B shows an exemplary method 320 for using the emotional insight data. Method 320 may begin at step 322 where the emotional insight data is received or otherwise obtained (e.g., from the API, as described above). At step 324, an application provides an output, interaction, intervention, or performs some other user-facing action based on the emotional insight data. For example, if the application communicates with the user, characteristics of the communication may be adjusted based on the emotional state of the user, as described above. If the application does not communicate with the user, other outputs may still be automatically adjusted based on the user's emotional state. For example, lighting or sound outputs may be adjusted to limit or reduce stress. Seat ergonomics may be adjusted to improve user comfort. Other examples are described above with respect to the various example applications 118, 124 of FIG. 1.

### Example Active Feedback Loop

FIG. 4 is a diagram illustrating example processing stages of the emotional intelligence engine 112 of FIG. 1. In this example, the emotional intelligence engine 112 performs four processing functions: preprocessing 402, active processing 404, post-processing 406, and regressive processing 408. An adaptive feedback loop 410 is used to provide real-time information via the API 120, while also allowing user profiles and predictions of user states (and the underlying models used for these predictions) to be improved over time.

During preprocessing 402, biodata is received by the data acquisition module 102 and preprocessed by the data preprocessing module 104. As illustrated in FIG. 4, preprocessing 402 may involve data normalization, heart rate variability (HRV) and interbit interval monitoring, vocal coding, etc. During active processing 404, biodata is correlated with any other received data, such as linguistic data, to generate fused data. Predictive personalized insights may be derived based on forward analysis of the fused data. In addition, baseline data may be established from the preprocessed data and the fused data. At post-processing 406, corrective actions may be taken with retroactive adjustments. During regressive processing 408, baselines are reconfirmed, and anomalies are identified. The four stages work together to create an adaptive feedback loop 410 that may continuously readjust emotional state determinations and user baselines based on real-time biodata.

In example embodiments, the predictive personalized emotional insights are provided to or made accessible to the API 120 operating on a user device or other device that allows for integration/interaction with existing resources/systems (e.g., GPS, etc.) on the device. For example, in determining that the user is stressed, the API may interact with the GPS residing on the user device to provide location guidance to destinations that would help reduce the stress level of the user. Other example implementations are described above.

The foregoing example implementation may have various benefits and advantages, as described elsewhere throughout this disclosure. As an additional example, by evaluating multidimensional real-time biofeedback data alongside linguistic data, example embodiments provide results with higher degree of confidence and accuracy than the prepossessed data and linguistic data viewed alone. In addition, predictive personalized insight can be generated and applied in real-time over existing systems/applications.

### Example Processing System

FIG. 5 is a block diagram illustrating an example of a processing system 500 in which at least some operations described herein can be implemented. For example, the emotional intelligence engine 112, user device 116, and other device 122 of FIG. 1 may be implemented as the example processing system 500. The processing system 500 may include one or more central processing units (“processors”) 502, main memory 506, non-volatile memory 510, network adapter 512 (e.g., network interfaces), video display 518, input/output devices 520, control device 522 (e.g., keyboard and pointing devices), drive unit 524 including a storage medium 526, and signal generation device 530 that are communicatively connected to a bus 516. The bus 516 is illustrated as an abstraction that represents any one or more separate physical buses, point to point connections, or both connected by appropriate bridges, adapters, or controllers. The bus 516, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, also called “Firewire.”

In various embodiments, the processing system 500 operates as part of a user device, although the processing system 500 may also be connected (e.g., wired or wirelessly) to the user device. In a networked deployment, the processing system 500 may operate in the capacity of a server or a client machine in a client-server network environment, or as a peer machine in a peer-to-peer (or distributed) network environment.

The processing system 500 may be a server computer, a client computer, a personal computer, a tablet, a laptop computer, a personal digital assistant (PDA), a cellular phone, a processor, a web appliance, a network router, switch or bridge, a console, a hand-held console, a gaming device, a music player, network-connected (“smart”) televisions, television-connected devices, or any portable device or machine capable of executing a set of instructions (sequential or otherwise) that specify actions to be taken by the processing system 500.

While the main memory 506, non-volatile memory 510, and storage medium 526 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 528. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 504, 508, 528) set at various times in various memory and storage devices in a computer, and that, when read and executed by one or more processing units or processors 502, cause the processing system 500 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. For example, the technology described herein could be implemented using virtual machines or cloud computing services.

Further examples of machine-readable storage media, machine-readable media, or computer-readable (storage) media include, but are not limited to, recordable type media such as volatile and non-volatile memory devices 510, floppy and other removable disks, hard disk drives, optical disks (e.g., Compact Disk Read-Only Memory (CD ROMS), Digital Versatile Disks (DVDs)), and transmission type media, such as digital and analog communication links.

The network adapter 512 allows the processing system 500 to mediate data in a network 514 with an entity that is external to the processing system 500 through any known and/or convenient communications protocol supported by the processing system 500 and the external entity. The network adapter 512 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 512 can include a firewall, which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

As indicated above, the techniques introduced here implemented by, for example, programmable circuitry (e.g., one or more microprocessors), programmed with software and/or firmware, entirely in special purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc.

The terms “a”, “an” and “the” are intended to include the plural forms as well, unless the context clearly indicates otherwise.

The terms “comprises” and/or “comprising”, when used in this specification, specify the presence of stated features, steps, operations, elements, and/or components, but do not preclude the presence or addition of one or more other features, integers, steps, operations, elements, components, and/or groups thereof.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

Several implementations of the disclosed technology are described above in reference to the figures. The computing devices on which the described technology may be implemented can include one or more central processing units, memory, input devices, output devices (e.g., display devices), storage devices, and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item, such as A and A; B, B, and C; A, A, B, C, and C; etc.

The above Detailed Description of examples of the technology is not intended to be exhaustive or to limit the technology to the precise form disclosed above. While specific examples for the technology are described above for illustrative purposes, various equivalent modifications are possible within the scope of the technology. For example, while processes are presented in a given order, alternative implementations may perform routines having steps in a different order, and some processes may be deleted, moved, added, subdivided, combined, and/or modified to provide alternative or sub-combinations. Each of these processes may be implemented in a variety of different ways. Also, while processes are at times shown as being performed in series, these processes or blocks may instead be performed or implemented in parallel or may be performed at different times. Further, any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
one or more sensors configured to collect biodata associated with a user; and
a processor in communication with the one or more sensors, the processor configured to:
receive the biodata associated with the user;
process the biodata using one or more artificial intelligence models to determine an emotional state of the user, wherein the emotional state is a prediction inferred by the processor based on psychophysiological signals derived from the biodata; and
generate an output, modification, or intervention based at least in part on the inferred emotional state of the user; and
a device configured to:
provide an initial output for the user;
receive or obtain the inferred emotional state of the user; and
modify or adjust the initial output provided to the user based at least in part on the inferred emotional state of the user.

2. The system of claim 1, wherein the processor is further configured to determine a user credibility weighting based at least in part on the received biodata.

3. The system of claim 1, wherein the processor is further configured to:
determine a cognitive load of the user based on the biodata; and
adapt complexity of information provided to the user as part of the modified or adjusted output based on the cognitive load.

4. The system of claim 1, wherein the device is further configured to:
provide an audible artificial voice interaction with the user; and
adjust properties of the audible artificial voice interaction based on the inferred emotional state of the user.

5. The system of claim 1, wherein the device is further configured to:
generate, using a reasoning algorithm, a linguistic cue to the user;
receive a response to the linguistic cue from the user;
adjust the reasoning algorithm based on the biodata; and
generate, using the adjusted reasoning algorithm, a modified linguistic cue taking into account the inferred emotional state of the user.

6. The system of claim 1, wherein the processor is further configured to preprocess the biodata by performing one or more of data normalization, data filtering, data transformation, and feature extraction and selection on the biodata.

7. The system of claim 1, wherein the processor is further configured to:
determine a longitudinal trend in the received biodata over a period of time;
detect a deviation in the inferred emotional state of the user; and
provide a proactive intervention for addressing the detected deviation in the inferred emotional state of the user.

8. The system of claim 1, wherein the device comprises an electronic display, speaker, a haptic device, lighting, an augmented reality display, or a virtual reality display.

9. The system of claim 1, wherein the device is a component of a vehicle, a smart home, a workspace, a lighting system, a sound system, a gaming system, or a virtual reality/augmented reality system.

10. The system of claim 1, wherein:
the biodata comprises multimodal data corresponding to a plurality of biometric signals of the user; and
the processor is further configured to:
preprocess the multimodal data to generate preprocessed multimodal data;
synchronize the preprocessed multimodal data to generate fused data; and
perform data interpolation and predictive modeling on the fused data to generate the prediction of the inferred emotional state of the user using the fused data as an input to the one or more artificial intelligence models.

11. The system of claim 10, wherein the processor is further configured to generate or update a profile of the user comprising at least one of psychographic, physiological, and cognitive characteristics of the user.

12. The system of claim 11, wherein the processor is further configured to iteratively update the prediction of the inferred emotional state of the user using a multi-stage feedback mechanism.

13. The system of claim 12, wherein the processor is further configured to predict a long-term emotional state of the user, using the predictions of the inferred emotional states that are iteratively updated over time.

14. The system of claim 1, wherein the device is further configured to:
present a user interface to the user; and
adjust properties of the user interface based on the inferred emotional state of the user.

15. The system of claim 1, wherein the device is further configured to:
provide one or both of lighting and sound to a space; and
adjust properties of one or both of the lighting and sound based on the inferred emotional state of the user.

16. The system of claim 1, wherein the device is a component of a vehicle and is further configured to modify at least one of seat ergonomics, ambient lighting, sound ambiance, air temperature, and haptic feedback based on the inferred emotional state of the user.

17. The system of claim 1, wherein the biodata comprises at least one of heart rate of the user, heart rate variability of the user, skin galvanic response of the user, facial micro-expression of the user, a respiration rate of the user, a vocal tone of the user, and a neural oscillation pattern of the user.

18. The system of claim 1, wherein the processor is further configured to:
detect any of both of a cognitive load, neurocognitive strain, or fatigue using the biodata; and
the device is further configured to receive an indication of the detected cognitive load, neurocognitive strain, and/or fatigue and provide a corresponding intervention.

19. The system of claim 1, wherein:
the one or more sensors are configured to collect group biodata associated with a group of users; and
the processor is configured to:
receive the group biodata;
process the group biodata using the one or more artificial intelligence models to determine a member emotional state of each individual in the group, wherein the member emotional state is a prediction inferred by the processor based on psychophysiological signals for each individual in the group derived from the group biodata; and
generate a group output, group modification, or group intervention based at least in part on the inferred emotional state of each individual in the group; and
the device is configured to:
provide group output, group modification, or group intervention to at least one individual in the group.

20. A method, comprising, by one or more processors:
receiving biodata associated with a user from one or more sensors;
preprocessing the biodata using data normalization, feature extraction and/or signal filtering techniques;
determining, using one or more artificial intelligence models and at least a portion of the biodata, an emotional state of the user, wherein the emotional state is a prediction inferred by the one or more processors based on psychophysiological signals derived from the biodata;
modifying or adjusting an output, interaction, or intervention provided to the user based at least in part on the inferred emotional state; and
iteratively updating the inferred emotional state using a feedback loop based on newly received biodata.

21. A system, comprising:
one or more sensors configured to collect biodata associated with a user; and
one or more processors in communication with the one or more sensors, the one or more processors configured to:
receive the biodata associated with the user;
process the biodata using one or more artificial intelligence models to determine an emotional state of the user, wherein the emotional state is a prediction inferred by the processor based on psychophysiological signals derived from the biodata;
generate an output, modification, or intervention based at least in part on the inferred emotional state of the user; and
provide the output, interaction, or the intervention for presentation to the user.
